(19) United States
(12) Patent Application Publication
(10) Pub. No.: US 2009/0223763 A1
(43) Pub. Date: Sep. 10, 2009

(54) SHOCK ABSORBER

(75) Inventor: Dirk Lude, Munchen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: GUSTAV MAGENWIRTH GMBH & CO. KG, Bad Urach (DE)

(21) Appl. No.: 12/400,855

(22) Filed: Mar. 10, 2009

(30) Foreign Application Priority Data
Mar. 10, 2008 (DE) 102008013359.0

(51) Int. Cl. F16F 9/34

(52) U.S. Cl. 188/322.15

(57) ABSTRACT

A shock absorber for a suspension fork or a suspension unit, especially for bicycles, with a damping space (4) filled with damping fluid (5), and a rebound piston (8) that engages in the damping space (4) and moves relative to the damping space for damping the rebound. A reservoir (14) receives displaced damping fluid for downward a deflection. A compression piston (16) is arranged in the damping space (4) for damping the compression. Through the arrangement of the compression damping unit in the form of a compression piston within the damping space, the construction of the shock absorber is significantly simplified, because the damping fluid no longer has to be guided through a channel in the rebound piston rod to the remote compression damper.

### BACKGROUND

The invention relates to a shock absorber, in particular for bicycles, with a damping space filled with damping fluid, with a rebound piston that is located in the damping space and that can move relative to this space for damping a rebound or shock and with a reservoir for receiving displaced damping fluid for downward deflection.

For bicycles, especially for mountain bikes, the use of suspension forks has recently become widespread, because they create a significant increase in riding safety and riding comfort.

Suspension forks generally have a spring unit and a shock absorber. Here, the shock absorber is divided into a compression damping unit for damping the downward deflection process, the so-called compression, and a rebound damping unit for damping the upward deflection process, the so-called rebound. In most suspension forks, the two dampers are arranged in one shock absorber in which damping oil flows through various channels and in this way the movement is damped. The rebound damping unit and/or the compression damping unit can be adjusted individually or preset at the factory.

In U.S. Pat. No. 7,163,222 B2, for example, such a suspension fork is shown, wherein the spring unit is housed in one fork leg and the shock absorber is housed in the other fork leg. Each fork leg has a stanchion tube and a slider tube, wherein the stanchion tube engages with the slider tube with a precision fit. The stanchion tubes are connected at their upper ends by a fork crown. The shock absorber has a compression damper that is arranged in the region of the fork crown in the stanchion tube. The piston rod of a rebound piston is connected to the stanchion tube similarly in the region of the fork crown. For rebound damping, the rebound piston is inserted in a damping space that is arranged in the lower region of the slider tube, but reaches partially into the stanchion tube. The damping space is filled with a damping oil. At the lower end of the damping space, there is a stationary base valve that connects the inner space of the damping space to the inner space of the slider tube, wherein the slider tube is used as a reservoir.

Within the rebound piston rod, there is a channel that connects the damping space to the compression damper. For downward deflection of the suspension fork, the rebound piston moves farther downward in the damping space. Here, a portion of the damping oil is forced through the channel within the rebound piston up to the compression damper, where the movement is damped. The oil is led from there back through the stanchion tube into the reservoir arranged in the slider tube. Another portion of the oil is forced through openings in the piston to its other side, wherein the openings are sealed with a cover plate biased by a spiral spring.

For upward deflection, the rebound piston moves upward and generates, in the damping space, a low pressure through which the oil is suctioned back out of the reservoir into the damping space.

This type of damping requires high structural expense, because the inner spaces of the stanchion tube and the slider tube come into contact completely with the damping oil. Accordingly, all of the components must be sealed from the outside in a complicated manner, so that no oil can leak out. In addition, the piston rod must be provided with a channel, which makes the production complicated and expensive.

Comparable dampers with a rebound piston and a compression piston are also known from DE 34 18 793 A1 and DE 937 624, wherein here the reservoir is in a coaxial arrangement around the damper cylinder. The reservoir and the damper cylinder there require complicated sealing. In this configuration, the oil flow takes place exclusively through openings in the piston, wherein these openings are sealed by a cover plate. The biasing of the cover plate is here realized, however, by a plate spring and not by a spiral spring.

In both arrangements, the oil volume is also relatively large, so that a lot of damping oil is needed for filling, which increases the weight of the suspension fork.

### SUMMARY

The object of the invention is therefore to create a shock absorber for a suspension fork or a suspension unit that is easier to build and can be used with less oil.

This is achieved according to the invention in that, in the damping space, there is a compression piston for damping the compression.

Through the arrangement of the compression damping in the form of a compression piston within the damping space, the construction of the shock absorber is significantly simplified, because the damping fluid no longer must be led through a channel in the rebound piston rod to the remote compression damping.

Here it is advantageous if the damping space is arranged completely within the stanchion tube, because in this way the assembly is significantly simplified and the sealing expense is low.

Preferably the damping space has an essentially cylindrical form and a coaxial arrangement within the stanchion tube, so that a gap is formed between the outer wall of the damping space and the inner wall of the stanchion tube. Through the reduced diameter in comparison with the stanchion tube, the volume of the damping space is reduced, whereby less damping fluid is required. This also produces savings in terms of weight.

With the arrangement of the damping space in the stanchion tube, it is especially useful when the rebound piston is mounted on the slider tube. This produces overall a simple arrangement of the shock absorber within the fork or the suspension unit. For downward deflection, the stanchion tube thus moves over the slider tube and the damping space is moved in the direction of the rebound piston. Viewed relatively, the rebound piston thus moves farther into the damping space.

Through this insertion process, damping fluid in the damping space is displaced, so that it is advantageous when the reservoir for the overflowing damping fluid is arranged in the stanchion tube. Preferably, the reservoir essentially lies at the end of the damping space opposite the rebound piston.

Through the essentially linear arrangement of the individual function elements, an especially simple construction of the shock absorber is possible.

In addition, for the shock absorber according to the invention, no other components are in contact with the damping fluid outside of the damping space and the reservoir. The sealing expense and the risk that damping fluid leaks out are significantly reduced in comparison with the state of the art.

It is advantageous when the damping space has a direct opening to the reservoir, wherein the damping fluid can flow back and forth unimpaired between the damping space and the reservoir through this opening. Therefore, the flow of damping fluid is not choked further and no additional components are required.

It is especially advantageous when the compression piston has an essentially technically identical construction compared with the rebound piston. This reduces development expense and the shock absorber can be produced more cost effectively.

One construction of the shock absorber according to the invention provides that the damping unit for damping the compression is a plate-valve damper unit.

The plate valve preferably has an initial breakaway force that is realized by biasing of the plate valve. Through the initial breakaway force it is achieved that the valve does not open immediately, but instead only when a pressure is applied that is greater than the biasing. In this way it is prevented that the damping already responds at a lower load and deflects downward unnecessarily, as, for example, when pedaling while standing up.

The biasing is preferably realized by two disks that are spaced apart from each other, wherein at least one spacer can be arranged between the two disks of the plate valve. Here it is useful when the distance between the two disks is greater in the outer region of the plate valve than the distance in the inner region. Therefore, the upper disk in the outer region is more strongly curved and thus generates the biasing for the plate valve damper unit.

For the plate valve damping, the initial breakaway moment essentially determines the starting point of the damping characteristic line. Through the selection of the biasing, that is, through the variation of the spacing between the disks, the damping characteristic line can be shifted in parallel. The form of the characteristic line is defined, in contrast, by other parameters.

In particular, the plate valve damper can be combined in an especially useful way with the compression piston according to the invention, so that a compression damper unit that is easy to realize and that can be produced economically is provided.

### BRIEF DESCRIPTION OF THE DRAWINGS

Additional advantageous features of the shock absorber according to the invention result are explained in greater detail below and shown in the drawings.

Shown are:

FIG. 1 is a longitudinal section view of a shock absorber according to the invention and

FIG. 2 is a detail view of the compression piston.

### DETAILED DESCRIPTION OF THE PREFERRED EMBODIMENTS

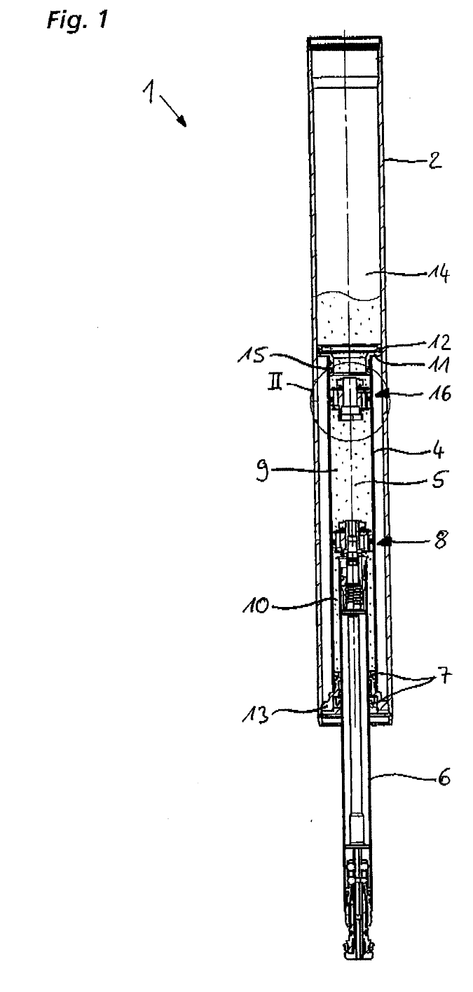

FIG. 1 shows a longitudinal section through a shock absorber of a suspension fork designated as a whole with 1 for a bicycle, especially for a mountain bike. The suspension fork has a stanchion tube 2 with a round cross section that is connected at the upper end to a fork crown not shown in greater detail and that engages with the lower end in a not-shown slider tube.

The shock absorber 1 has a cylindrical damping space 4 formed by an oil retaining tube that has a coaxial arrangement in the stanchion tube 2 and that is open at both ends. The lower end of the oil retaining tube 4 is aligned at the lower end of the stanchion tube 2 and is attached by a flange 13 inserted into the oil retaining tube 4. The oil retaining tube 4 is filled completely with damping oil 5.

A piston rod 6 attached at the lower end of the slider tube is inserted from below in the lower end of the oil retaining tube 4. At the passage position into the flange 13, a sliding seal 7 is arranged that seals the damping space 4 at the bottom, so that no damping oil 5 can escape from the damping space 4 into the slider tube.

At the end of the piston rod 6 there is a rebound piston 8 of a known rebound damping unit, wherein the rebound piston 8 can move within the damping space 4 and divides the damping space 4 into a compression chamber 9 and a bypass chamber 10.

At the upper end of the oil retaining tube 4 there is a radial flange 11 that is directed outward and that is connected by a seal 12 to the inner wall of the stanchion tube 2. Above the oil retaining tube 4, the inner space of the stanchion tube 2 is used as a reservoir 14 for the damping oil 5. The reservoir 14 is connected by the upper, open end 15 of the oil retaining tube 4 to the compression chamber 9.

Opposite the rebound piston 8, in the region of the upper opening 15 of the damping space 4 there is a compression piston 16 that is connected rigidly to the wall 17 of the oil retaining tube 4, preferably by a crimped connection 30, for the compression damping.

In the relaxed state of the shock absorber 1, the rebound piston 8 contacts the bottom end of the damping space 4. When the shock absorber 1 is deflected downward, the stanchion tube 2 slides farther over the slider tube, whereby the damping space 4 is also moved downward. Therefore, the rebound piston 8 is moved upward relative to the damping space 4. The damping fluid 5 here flows through openings in the rebound piston 8 out of the compression chamber 9 into the bypass chamber 10. Due to the volume displacement of the piston rod 6, the oil level, however, increases overall, so that damping oil 5 is displaced out of the damping space 4 into the reservoir 14.

The damping oil 5 here flows through the compression piston 16 that causes damping of the fluid flow and thus the downward deflection process.

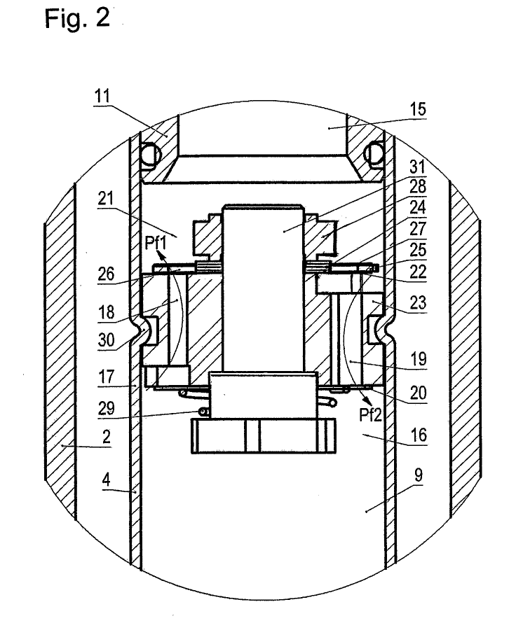

FIG. 2 shows a detail view of the compression piston 16. For downward deflection, the damping oil 5 flows in the arrow direction Pf1 through the compression opening 18 shown on the left in the piston 23 from the compression chamber 9 into the reservoir 14. The rebound opening 19 on the right side is closed by a non-return valve 20 on the compression-chamber side.

The compression opening 18 is sealed on the reservoir side by a plate valve 21, a so-called shim packet. The plate valve 21 has a cover disk 22 that lies directly on the piston 23 and covers the compression opening 18. On the cover disk 22 there are one or more biasing disks 24 in the inner region, wherein these disks have a smaller outer diameter than the cover disk 22. On the outer periphery of the cover disk 22, in the outer region, at least one control disk 25 is placed that has the same or a larger thickness than the biasing disk 24. The control disk 25 has the same outer diameter as the cover disk 22, but a larger inner diameter. Between the biasing disk 24 and the control disk 25, a hollow space 26 is formed. The biasing disk 24 and the control disk 25, however, can also be formed in one part.

On the biasing disk 24 and the control disk 25 there is a support disk 27 that corresponds in size to the cover disk 22 and that is pressed by a nut 28 on the central piston rod 31 on the inner periphery onto the biasing disk 24.

Due to the different thicknesses of the biasing disk 24 and the control disk 25, biasing is generated onto the cover disk 22 that leads to a defined initial breakaway moment for the plate valve 21. The damping fluid 5 can open the plate valve 21 only when the oil pressure in the compression chamber 9 exceeds the biasing of the plate valve 21. Therefore, the compression damping obtains a characteristic line that starts at a minimum force corresponding essentially to the biasing of the plate valve. By exchange of the biasing disk 24 and/or the control disk 25, it is possible to change the biasing and thus to shift the characteristic line on the force axis. By increasing the biasing, the characteristic line essentially shifts upward in parallel to larger forces. By reducing the biasing, the characteristic line 34 is shifted to lower forces. The form of the characteristic line, however, is not influenced.

Through the simple adjustment of the characteristic line by the biasing, first, weight is saved, because no complicated adjustment mechanism has to be provided and, simultaneously, the reliability is increased, because no moving parts are also needed.

For upward deflection, the rebound piston 8 is moved from the damping space 4, wherein damping fluid 5 flows out of the bypass chamber 10 through the rebound piston 8 and is damped there by a plate valve, wherein the rebound plate valve has an essentially technically identical form compared with the compression plate valve 21.

In the compression piston 16, the plate valve 21 automatically closes and through the resulting low pressure in the compression chamber 9, the non-return valve 20 on the rebound opening 19 is opened, wherein the non-return valve 20 is supported by a spiral spring 29. The damping fluid 5 can thus flow in the arrow direction Pf2 from the reservoir 14 back into the compression chamber 9.

### REFERENCE SYMBOLS

1 Shock absorber
2 Stanchion tube
3 Suspension crown
4 Damping space/oil retaining tube
5 Damping oil
6 Piston rod (rebound piston)
7 Sliding seal
8 Rebound piston
9 Compression chamber
10 Rebound chamber
11 Flange, top
12 Seal
13 Flange, bottom
14 Reservoir
15 Open end, top
16 Compression piston
17 Wall of the compression space
18 Compression opening
19 Rebound opening
20 Non-return valve
21 Plate valve
22 Cover plate
23 Piston (compression)
24 Biasing plate
25 Control disk
26 Hollow space
27 Support disk
28 Nut
29 Spiral spring
30 Crimped connection
31 Piston rod (compression piston)
Pf1 Direction of flow, compression
Pf2 Direction of flow, rebound

1. Shock absorber for a suspension fork or a shock unit for bicycles, comprising a damping space (4) filled with damping fluid (5), with a rebound piston (8) that engages in the damping space (4) and that moves relative to the damping space for damping a rebound and with a reservoir (14) for receiving displaced damping fluid from downward deflection, and a compression piston (16) is arranged in the damping space (4) for damping a compression.

2. Shock absorber according to claim 1, wherein the compression piston (16) has at least one opening (18) for allowing a flow of damping fluid (5) during the compression.

3. Shock absorber according to claim 2, wherein the compression opening (18) has a plate valve (21) that seals the compression opening (18) during the rebound.

4. Shock absorber according to claim 1, wherein the compression piston (16) has at least one opening (19) for allowing a flow of damping fluid (5) during the compression.

5. Shock absorber according to claim 4, wherein the rebound opening (19) has a non-return valve (20) that seals the rebound opening (19) during the compression.

6. Shock absorber according to claim 1, wherein the damping space (4) is arranged and fixed completely within a stanchion tube (2).

7. Shock absorber according to claim 6, wherein the damping space (4) has an essentially cylindrical form and that a gap is formed between an outer wall of the damping space and an inner wall of the stanchion tube.

8. Shock absorber according to claim 1, wherein the rebound piston (8) is mounted on a slider tube.

9. Shock absorber according to claim 1, wherein a reservoir (14) for the overflowing damping fluid (5) is arranged in a stanchion tube (2).

10. Shock absorber according to claim 9, wherein the damping space (4) has a direct opening (15) for the reservoir (14), wherein damping fluid (5) can flow back and forth unimpaired between the damping space (4) and the reservoir (14) through the direct opening.

11. Shock absorber according to claim 10, wherein the reservoir (14) is arranged generally at an end of the damping space (4) opposite the rebound piston (8).

12. Shock absorber according to claim 1, wherein the compression piston (16) is arranged opposite the rebound piston (8).

13. Shock absorber according to claim 1, wherein the compression piston (16) is formed generally the same as the rebound piston (8).

14. Shock absorber for a suspension fork or a shock unit for bicycles, comprising a damping space (4) filled with damping fluid (5), a rebound piston (8) that engages in the damping space (4) and that moves relative to the damping space for damping a rebound and with a reservoir (14) for receiving displaced damping fluid for downward deflection, and a damping unit for damping compression comprising a plate valve damping unit.

15. Shock absorber according to claim 14, further comprising a plate valve (21) has an initial breakaway force that is created by biasing of the plate valve (21).

16. Shock absorber according to claim 15, wherein the biasing of the plate valve (21) is created by two disks (22, 27) that are spaced apart from each other.

17. Shock absorber according to claim 16, wherein a distance between the two plates (22, 27) in an outer region of the plate valve (21) is equal to or greater than in an inner region.

18. Shock absorber according to claim 17, at least one spacer is arranged between the two disks (22, 27) of the plate valve (21).

19. Shock absorber according to claim 18, wherein at least one biasing disk (24) is arranged between the two disks (22, 27) of the plate valve (21) in the inner region and at least one control disk (25) is arranged in the outer region.

20. Shock absorber according to claim 19, wherein a characteristic line of the plate valve damping unit is adjustable by changing the initial breakaway moment.
